(19) United States
(12) Patent Application Publication
(10) Pub. No.: US 2003/0164294 A1
(43) Pub. Date: Sep. 4, 2003

(54) Automated ion analyzer

(76) Inventors: Craig B. Ranger, Glendale, WI (US); Karin L. Bogren, Milwaukee, WI (US); Ninglan Liao, Milwaukee, WI (US); Craig P. Korn, Menomonee Falls, WI (US); Timothy J. Bahowick, Greenfield, WI (US); Eric C. Dauenhauer, Brookfield, WI (US)

Correspondence Address: Robert A. Van Someren, Fletcher, Yoder & Van Someren, P.O. Box 692289, Houston, TX, 77269-2289, US

(21) Appl. No.: 10/087,213

(22) Filed: Mar. 1, 2002

(51) Int. Cl. G01N 27/26

(52) U.S. Cl. 204/406; 205/789

(57) ABSTRACT

An analytical system to determine the presence of specific constituents in a liquid stream. The analytical system is an automated system that facilitates the testing of one or more samples according to a variety of methods. The methods may be of varying levels of complexity and may be run either in parallel or sequentially.

### FIELD OF THE INVENTION

The present invention relates generally to analytical systems for determining the presence of specific constituents in a liquid stream, and particularly to an automated system, such as a computer controlled system, for routing various liquids to generate reaction products that can be measured at an appropriate detector.

### BACKGROUND OF THE INVENTION

A variety of analytical products are commercially available to measure chemical, physical and microbiological species with varying degrees of automation. One exemplary technique for analyzing samples and determining specific constituents within the samples is flow injection analysis. Flow injection analysis utilizes a variety of reagents that are mixed with a given sample to create a reaction product. The reaction product is then measured at an appropriate detector to determine a specific constituent within the sample. For example, a given reagent may create a color change in the presence of a specific constituent, and such color change can be detected and/or measured via an appropriate detector. However, flow injection analysis typically includes the interaction of a technician rather than being accomplished on a fully automated system.

### SUMMARY OF THE INVENTION

The present invention features a technique to determine specific constituents in a liquid stream. The technique utilizes a controller in combination with a variety of subcomponents able to automatically control the flow of fluids, such as sample material, carrier fluid, reagents and wash solution, to perform flow injection analysis. The system incorporates appropriate detectors and software to quantitatively determine specific constituents.

### BRIEF DESCRIPTION OF THE DRAWINGS

The invention will hereafter be described with reference to the accompanying drawings, wherein like reference numerals denote like elements, and:

FIG. 1 is a schematic view of an automatically controlled analytical system, according to one embodiment of the present invention;

FIG. 2 is a flow chart representing general functionality of the system of FIG. 1; and

FIG. 3 is a detailed schematic representation of one exemplary embodiment of the present invention.

### DETAILED DESCRIPTION OF EXEMPLARY EMBODIMENTS

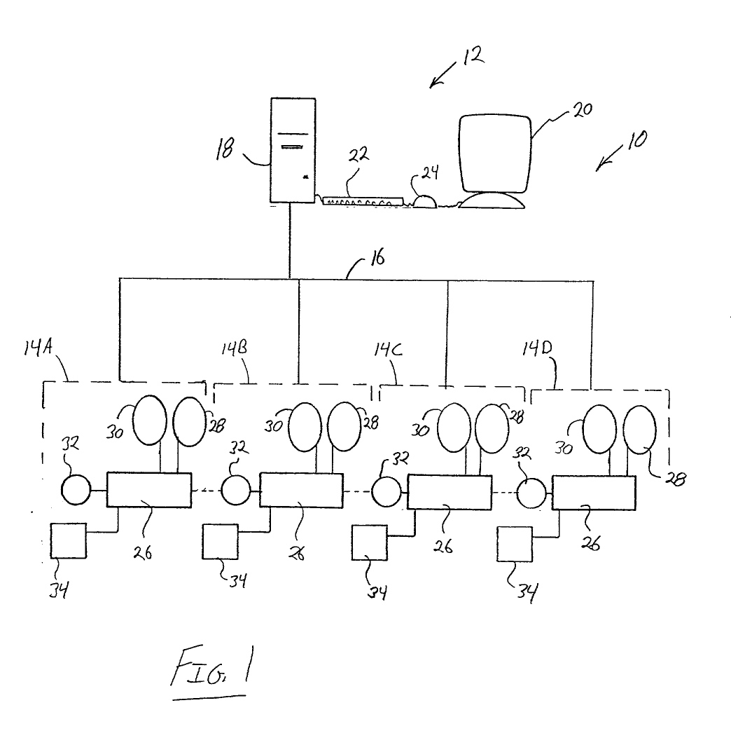

Referring generally to FIG. 1, an automated analytical system 10 is illustrated. System 10 is designed primarily for use in flow injection analysis. Specifically, a controller 12 is communicatively coupled to a plurality of automated flow injection analyzers 14 via appropriate control lines 16. It should be noted that control lines 16 can be wireless control lines.

An exemplary controller 12 is a computer controller having a CPU 18; a graphical user interface 20, such as a computer monitor; and other interface components, such as a keyboard 22 and a mouse 24. The overall configuration of controller 12 and the techniques for allowing a user to interface with the automated analytical system 10, however, can vary depending on power requirements, overall system design, advances or changes in technology, etc.

Each of the exemplary flow injection analyzers 14 has several component subsystems that are controlled via controller 12. For example, each analyzer 14 may comprise an analytical manifold 26 that cooperates with an automated reagent system 28, an automated fluid carrier system 30, an automated sample injection system 32 and a detector 34 able to determine certain constituents within a reaction product. For example, one type of detector 34 is able to determine the presence of a constituent by detecting the color of the reaction product. Often, a given detector 34 comprises software to determine constituents, as known to those of ordinary skill in the art.

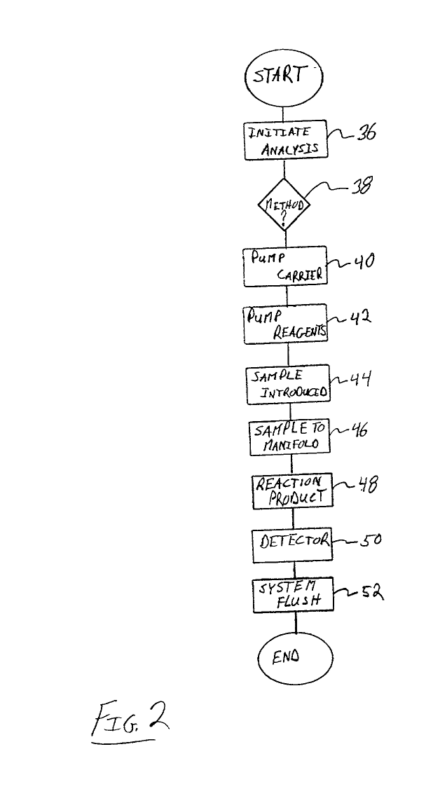

With reference to FIG. 2, the general functionality of a given system is described. Upon appropriate input from an operator, controller 12 initiates the analysis of a given sample or samples (block 36). The exemplary control system then allows the operator to select one or more methods of analysis via one or more analytical manifolds selected from the flow injection analyzers, such those shown in FIG. 1 and delineated as 14A, 14B, 14C and 14D (block 38). Once the desired methods of analysis are selected, controller 12 controls the pumping of a carrier fluid and one or more reagents (blocks 40, 42) through the appropriate analytical manifolds to establish a stable base line. A sample is then aspirated and pumped into the system (block 44). Subsequently, the sample is moved via the carrier fluid into the appropriate manifolds (block 46) either sequentially or in parallel. The introduction of the sample, as well as the introduction of the carrier fluid to move the sample, is automatically implemented via controller 12.

Within the appropriate analytical manifolds 26 (see FIG. 1), the sample is mixed with one or more reagents to generate a reaction product (block 48) that is automatically pumped to the corresponding detector 34 (see FIG. 1). Detector 34 is able to determine a specific constituent within the sample (block 50). Once each of the samples is processed according to the desired methods, controller 12 automatically flushes the system with, for example, deionized water (block 52). Of course, the methodology and functionality described is exemplary and should not be construed as limiting.

The actual analytical process can be adjusted according to a given application or to accommodate, for example, other or additional system components. Additionally, various aspects of the process described can be carried out in parallel or in series. In series, the process described with reference to FIG. 2 may be substantially carried out for one analytical manifold and then repeated at one or more additional manifolds 26.

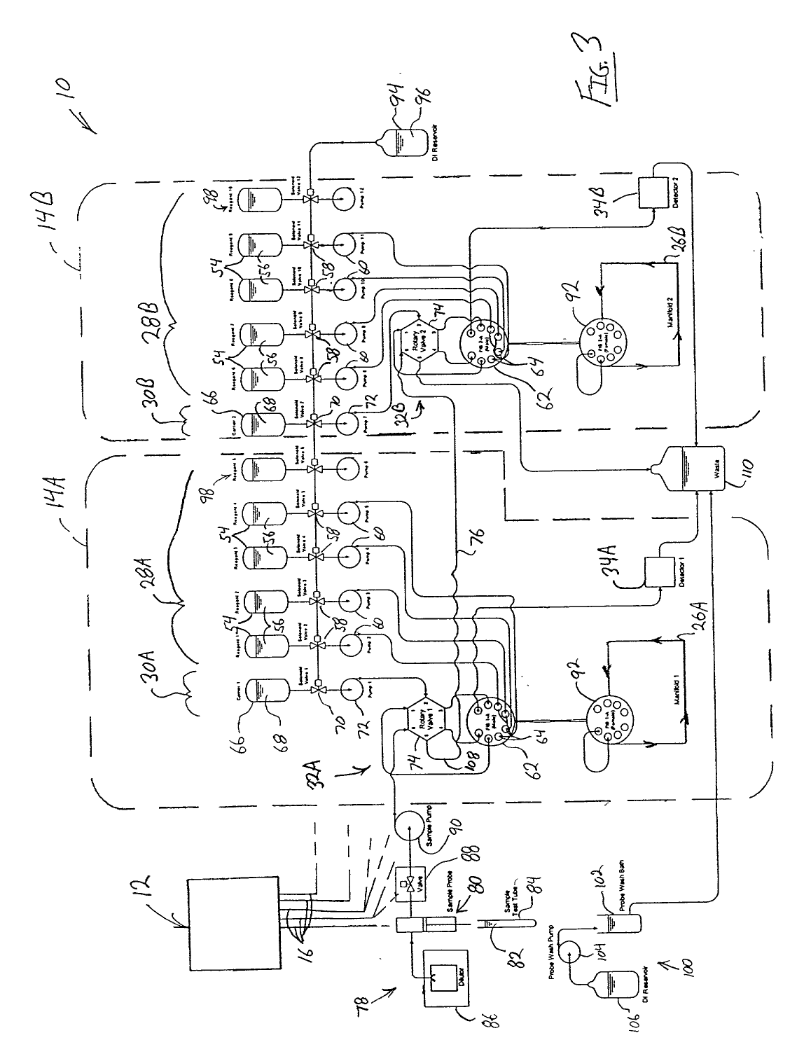

A detailed exemplary embodiment of automatic analytical system 10 is illustrated in detail in FIG. 3. In this specific example, system 10 comprises a pair of analyzers, such as analyzers 14A and 14B. As discussed above, each of the analyzers comprises an analytical manifold 26A and 26B, respectively. Also, each analyzer comprises a reagent system 28A, 28B and carrier system 30A, 30B. Again, as described with reference to FIG. 1, each analyzer also comprises a sample injection system 32A, 32B and a detector 34A, 34B.

Exemplary reagent systems 28A, 28B each comprise a plurality of reagent sources or reservoirs 54 containing specific reagents 56. It should be noted that the number of reservoirs 54 and reagents 56 can vary substantially within each analyzer 14A, 14B and within the overall system 10. This provides great flexibility in test methods utilized. For example, more complex and less complex methods can be carried out either simultaneously, i.e. in parallel, or sequentially in a variety of desired orders. This applies whether the system is set up for two test methods (FIG. 3), three test methods, four test methods (FIG. 1) or more.

Each reservoir 54 is fluidically coupled to a solenoid valve 58 controlled by controller 12 which in this specific example is a computer controller. Solenoid valves 58 are each coupled to corresponding pumps 60, e.g. peristaltic pumps, also controlled by computer control system 12. In each analyzer 14A, 14B, the pumps 60 are fluidically coupled with a first fluidic interface bus 62 having a plurality of ports 64 through which reagent is received from a corresponding pump.

Carrier systems 30A, 30B each comprise at least one carrier source or reservoir 66 designed to hold a carrier fluid 68. Each carrier reservoir is fluidically coupled with a solenoid valve 70 controlled by computer control system 12. A carrier pump 72, such as a peristaltic pump, is fluidically coupled to the solenoid valve 70 and delivers carrier fluid 68 to sample injection systems 32A, 32B, respectively. Pumps 72 also are controlled by computer control system 12.

In an exemplary embodiment of sample injection systems 32A, 32B, a mechanism, such as a rotary valve 74, is fluidically coupled to the appropriate carrier pump 72 to precisely introduce a sample into a carrier stream. Each rotary valve 74 is fluidically coupled with the corresponding fluidic interface buss 62. Additionally, the rotary valves 74 of each analyzer are fluidically coupled. In the example illustrated, rotary valve 74 of analyzer 14A is fluidically coupled with rotary valve 74 of analyzer 14B via a crossover line 76. Also, each rotary valve 74 is fluidically coupled with its corresponding fluidic interface buss 62 to deliver samples via carrier fluid 68.

Delivery of a desired sample or samples to rotary valves 74 is initiated at a sample supply system 78. In the specific example shown in FIG. 3, sample supply system 78 is coupled to the rotary valve 74 of analyzer 14A which, in turn, is coupled to the rotary valve 74 of analyzer 14B via crossover line 76. The sample supply system 78 comprises a sample probe 80 controlled by computer control system 12 to selectively draw a sample liquid 82 from a reservoir, such as a test tube 84. Sample probe 80 may also be coupled to a diluter 86.

The flow of sample from sample probe 80 is controlled via a valve 88 and a sample pump 90. Each of these components is controlled via computer controller 12 to automatically draw sample from sample reservoir 84, open valve 88 and deliver the sample, via pump 90, to rotary valve 74 of analyzer 14A. Here, the rotary valve 74 of analyzer 14A is actuated via computer control system 12 to direct sample liquid 82 to desired locations. For example, the sample liquid may be maintained at analyzer 14A for delivery to the corresponding fluidic interface buss 62 or the sample liquid may be delivered to other rotary valves at other analyzers, e.g. analyzer 14B. The sample liquid can be allowed to flow to each rotary valve for capture in an appropriate sample loop for analysis.

Each analyzer 14A, 14B also comprises a second fluidic interface buss 92 that typically forms a part of the corresponding manifold 26A, 26B and is fluidically coupled with first fluidic interface buss 62. Second fluidic interface buss 92 facilitates the introduction of desired reagents onto the manifold 26A, 26B where they are mixed with the sample.

Other features of automatic ion analyzer system 10 include a reservoir 94 coupled to solenoid valves 58 and 70. Reservoir 94 is designed to hold a wash fluid, such as deionized water, that can be pumped through each analyzer upon completion of analysis to rinse the system. Additionally, each analyzer 14A, 14B may comprise optional or additional reservoirs for holding either reagents or carriers. An exemplary additional reservoir, valve and pump system 98 is illustrated for each analyzer. The system may also include a probe washing system 100 having, for example, a probe wash bath 102, a probe wash pump 104 and a reservoir 106 of wash fluid, e.g. deionized water. Probe wash pump 104 is fluidically coupled to reservoir 106 to deliver wash fluid to probe wash bath 102 for the rinsing of sample probes.

In an exemplary operation, an initial method of analysis is performed on flow injection analyzer 14A. Initially, solenoid valves 58 and 70 are switched via computer control system 12 to permit the flow of wash solution. Subsequently, at a pre-programmed time, the solenoid valves are switched to enable the introduction of carrier fluid 68 and reagents 56. Pumps 72 and 60 are operated at a desired speed, typically preprogrammed into controller 12. The carrier fluid 68 and reagents 56 are pumped through fluidic interface busses 62 and 92 as well as manifold 26A and detector 34A to establish a stable base line. Then, a sample is aspirated under computer control from reservoir 84 via sample probe 80. The sample liquid is moved through valve 88 and sample pump 90 and delivered to rotary valve 74 of analyzer 14A.

The rotary valve 74 is automatically actuated via control system 12 and the sample is moved into a sample loop 108. The rotary valve 74 is then automatically rotated to place sample loop 108 in line with carrier fluid 68 which moves the sample out of sample loop 108 and into fluidic interface buss 62. From fluidic interface buss 62, the sample is moved via carrier fluid 68 to second fluidic interface buss 92 and manifold 26A.

The sample is then mixed on manifold 26A with the desired reagents 56 to generate a reaction product, e.g. a product with a color change, which is pumped through detector 34A. The detector 34A is designed to detect whether a change has occurred to the sample indicative of a specific constituent or constituents within the sample, as known to those of ordinary skill in the art. The sample passes through detector 34A and into a waste 110. Simultaneously or sequentially, the sample liquid also can be analyzed on analytical manifold 26B of analyzer 14B according to a second method. If the system contains additional analyzers, e.g. 14C and 14D, the sample also may be tested according to a variety of other additional methods.

Once the samples are analyzed, solenoid valves 70 and 58 of each applicable analyzer are switched via computer control system 12 to place them in line with reservoir 94. The applicable pumps 72, 60 move the wash fluid, e.g. deionized water, through the corresponding rotary valves 74, fluidic interface busses 62, 92, manifolds 26A, 26B and detectors 34A, 34B to rinse the components. Following a suitable rinse, the pumps 72, 60 are automatically shut off via computer control system 12. Thus, the system allows for the automatic analysis of sample liquid via flow injection analysis according to a variety of methods that may be of varying complexity. The overall system provides an operator with great versatility and ease in analyzing samples.

It will be understood that the foregoing description is of preferred embodiments of this invention, and that the invention is not limited to the specific forms shown. For example, a variety of control programs may be utilized based on specific applications and/or desired flexibility in selection of test parameters. The number of analyzers, as well as the number of reagents and other components in each analyzer, may be changed; and the type of manifolds and other components may vary from analyzer to analyzer and from system to system. These and other modifications may be made in the design and arrangement of the elements without departing from the scope of the invention as expressed in the appended claims.

What is claimed is:

1. A method of determining a specific constituent in a liquid stream, comprising:
selecting a sample for testing;
programming the controlled movement of the sample through selected configurations of analytical manifolds;
controlling via computer control the sample flow; and
automatically measuring a reaction product to complete a flow injection analysis.

2. The method as recited in claim 1, wherein controlling the sample flow comprises utilizing computer control over the pumping of one or more reagents through each analytical manifold.

3. The method as recited in claim 2, wherein controlling comprises automatically pumping the sample and the reagents into a fluidic interface buss.

4. The method as recited in claim 3, wherein controlling comprises automatically mixing the sample with the one or more reagents on each analytical manifold.

5. The method as recited in claim 4, wherein controlling comprises automatically rinsing the analytic manifolds with an appropriate wash solution.

6. The method as recited in claim 1, wherein controlling comprises automatically adjusting a rotary valve to select a desired analytical manifold to receive the sample.

7. The method as recited in claim 1, wherein controlling comprises sequentially analyzing the sample in two or more analytical manifolds.

8. The method as recited in claim 1, wherein controlling comprises analyzing the sample in parallel on separate analytical manifolds.

9. An automated ion analyzer, comprising:
a flow injection analyzer having a plurality of analytical manifolds; and
an automated control system coupled to the flow injection analyzer, the automated control system being configured to control an analysis of a sample on one or more of the analytical manifolds selected by an operator.

10. The automated ion analyzer as recited in claim 9, wherein the flow injection analyzer comprises a plurality of computer controlled valves to selectively release carrier fluid and reagent.

11. The automated ion analyzer as recited in claim 10, wherein the flow injection analyzer comprises a plurality of computer controlled pumps.

12. The automated ion analyzer as recited in claim 11, wherein at least one pump comprises a reagent pump.

13. The automated ion analyzer as recited in claim 11, wherein at least one pump comprises a carrier pump.

14. The automated ion analyzer as recited in claim 11, wherein at least one pump comprises a sample pump.

15. The automated ion analyzer as recited in claim 11, wherein the flow injection analyzer comprises a computer controlled rotary valve to automatically control the injection of a sample onto a selected analytical manifold.

16. The automated ion analyzer as recited in claim 11, wherein the automated control system comprises a computer control system.

17. An analytical system for determining the presence of specific constituents in a liquid stream, comprising:
a sample routing system;
a reagent mixing system to selectively mix a plurality of reagents with a sample;
a reaction product detector; and
a control system to automatically control routing of the sample through the sample routing system, mixing of the plurality of reagents with the sample and routing of the reaction product to the reaction product detector.

18. The analytical system as recited in claim 17, wherein the control system comprises a computer control coupled to a plurality of pumps and a plurality of valves to selectively control flow of a sample and the plurality of reagents.

19. The analytical system as recited in claim 18, wherein the reagent mixing system comprises a plurality of analytical manifolds independently coupled to a unique reagent supply, the plurality of analytical manifolds being individually computer controlled.
